(19) United States
(12) Patent Application Publication
(10) Pub. No.: US 2006/0190635 A1
(43) Pub. Date: Aug. 24, 2006

(54) Information processing apparatus and state control method of the same apparatus

(76) Inventor: Akihiro Kojou, Hamura-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/353,362

(22) Filed: Feb. 14, 2006

(30) Foreign Application Priority Data
Feb. 14, 2005 (JP) 2005-036576

(51) Int. Cl. G06F 3/00

(52) U.S. Cl. 710/15

(57) ABSTRACT

According to a state control method used for an information processing apparatus of the present invention, an OS transits each device state of predetermined devices configuring the system of a computer to a state D3. Devices capable of transiting to D3hot are transited to a state D3hot, on the other hand, devices incapable of transiting to D3hot are transited to a state D3cold. A system BIOS determines that an AC adapter is in a connected state. If a device transiting to the state D3cold exists, the system BIOS initializes the devices of state D3cold to transit them to a state D0. Thereafter, the system BIOS transits the state of a CPU to a state Cx.

### CROSS-REFERENCE TO RELATED APPLICATIONS

This application is based upon and claims the benefit of priority from Japanese Patent Application No. 2005-036576, filed Feb. 14, 2005, the entire contents of which are incorporated herein by reference.

### BACKGROUND

1. Field

The present invention relates to an information processing apparatus, and a state control method of the same apparatus. In particular, the present invention relates to a method of transiting (changing) a system state into a high-speed returnable state to S0 defined according to an ACPI specification.

2. Description of the Related Art

In recent years, various battery-powered personal computers have been developed. In such personal computers, a power management technique has been developed. According to the power management technique, power consumption is reduced, and the time for returning a system state to an operating state is shortened. There is known an Advanced Configuration and Power Interface (ACPI) specification as the foregoing power management technique.

According to the ACPI specification, in addition to an operating state and shutdown state, several sleep states are defined as a system state between the foregoing operating and shutdown states.

The ACPI specification defines system states S0 to S5. The system state S0 is an operating state (i.e., state that system power is turned on, and software is executed). System state S5 is an off state (i.e., state that execution of software ends, and system power is turned off). Each of system states S1 to S4 is a state between the foregoing S0 and S5 (i.e., a so-called sleep state wherein the operating system is shut down while keeping a software execution state).

In system state S1, context of all components (CPU, memory, chipset) configuring the system and power supplied to these components are kept. However, the supply of clock to the CPU is stopped. Power consumption in system state S1 is the maximum in the sleep states; however, state S1 is returnable to system state S0 at high speed.

In system state S2, CPU and system cache are not supplied with power. Therefore, power consumption required for system state S1 decreases as compared with that required for system state S1.

In system state S3, power of a system memory (and partial chipset) is maintained. In other words, the context of the system memory (and partial chipset) is maintained. Power consumption required for system state S3 further decreases as compared with that required for system state S2.

In system state S4, a non-volatile storage such as hard disk is stored with all of contexts of the system memory, and the power supply to components other than the non-volatile storage is stopped. Power consumption in system state S4 is the minimum (equal to system state S5) in the sleep states. However, state S4 requires the most time to return to state S0 in the sleep states. In other words, system state S4 is the “deepest” of the sleep states.

Before transiting from state S0 to each sleep state, contexts stored in the system memory are saved. When the system state returns from states S1 to S4 to state S0, the saved contexts are restored; therefore, software is continuously operable after return to state S0.

The relationship between power consumptions of system states and the relationship of time returnable to S0 from S1 to S5 are as follows.

Power consumption: S0>S1>S2>S3>S4>S5

Returnable time: S1<S2<S3<S4<S5

For example, JPN. PAT. APPLN. KOKAI Publication No. 11-194846 (page 17, FIG. 11) discloses a technique related to the sleep state in the system states defined according to the foregoing ACPI specification. According to the technique, transition between sleep states is dynamically made in accordance with a change of the power supply to computer.

The technique disclosed in the foregoing

Publication No. 11-194846 is employed, and thereby, transition between sleep states of the system states defined by the ACPI specification is dynamically made. For example, transition from state S5 to state S3 is possible. The system state transits from state S5 to state S3, and thereby, time spent for returning to state S0 is shortened.

However, user has the following needs. Specifically, user desires to return the system state to state S0 at time shorter than time spent for returning to S0 from system state S3 defined by the ACPI specification.

### BRIEF SUMMARY

According to an embodiment of the present invention, there is provided an information processing apparatus. The apparatus comprises a device configured to support a specification defined in ACPI; a processor configured to support a specification defined in ACPI; a first state control unit configured to transit a state of the device to a first state requiring no initialization in return; and a second state control unit configured to transit a state of the processor to a second state requiring no initialization in return.

According to an another embodiment (another aspect) of the present invention, there is provided a state control method used for an information processing apparatus including a device configured to support a specification defined in ACPI and a processor configured to support a specification defined in ACPI. The method comprises transiting a state of the device to a first state requiring no initialization in return; and transiting a state of the processor to a second state requiring no initialization in return.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an example of information processing apparatus to which a state control method according to an embodiment of the present invention is applied, that is, notebook personal computer, and showing a state that a display unit is opened with respect to a main body;

FIG. 2 is a functional block diagram to explain an example of the configuration of an information processing apparatus to which a state control method according to an embodiment of the present invention is applied, that is, notebook personal computer;

FIG. 3 is a concept view to explain an example of the relationship between a system state in the state control method according to the embodiment and a system state defined in ACPI;

FIG. 4 is a flowchart to explain an example of the procedure of transiting a system state to state S5 or S4 after a state S3_fast mode is set in the state control method according to the embodiment;

FIG. 5 is a view showing an example of a BIOS setup screen for setting a state S3_fast mode in the state control method according to the embodiment;

FIG. 6 is a view showing an example of a screen for specifying a system state in the state control method according to the embodiment;

FIG. 7 is a flowchart to explain an example of the procedure of transiting from state S5, S4 or S3 to a state S3_fast in the state control method according to the embodiment;

FIG. 8 is a flowchart to explain an example of the procedure of transiting to a state S3_fast in the state control method according to the embodiment;

FIG. 9 is a conceptual view to explain another example of the relationship between a system state in the state control method according to the embodiment and a system state defined in ACPI;

FIG. 10 is a flowchart to explain an example of the procedure of transiting from a state S0 to a state S3_fast in the state control method according to the embodiment;

FIG. 11 is a view showing an example of a BIOS setup screen for setting a state S3_fast mode in the state control method according to the embodiment;

FIG. 12 is a view showing an example of a utility screen for setting a state S3_fast mode in the state control method according to the embodiment;

FIG. 13 is a flowchart to explain an example of the transition flow from a state S3_fast to a state S3, and the transition flow from state S3 to state S3_fast in the state control method according to the embodiment; and

FIG. 14 is a flowchart to explain an example of the procedure of transiting a system state from a state S3_fast to a state S3.

### DETAILED DESCRIPTION

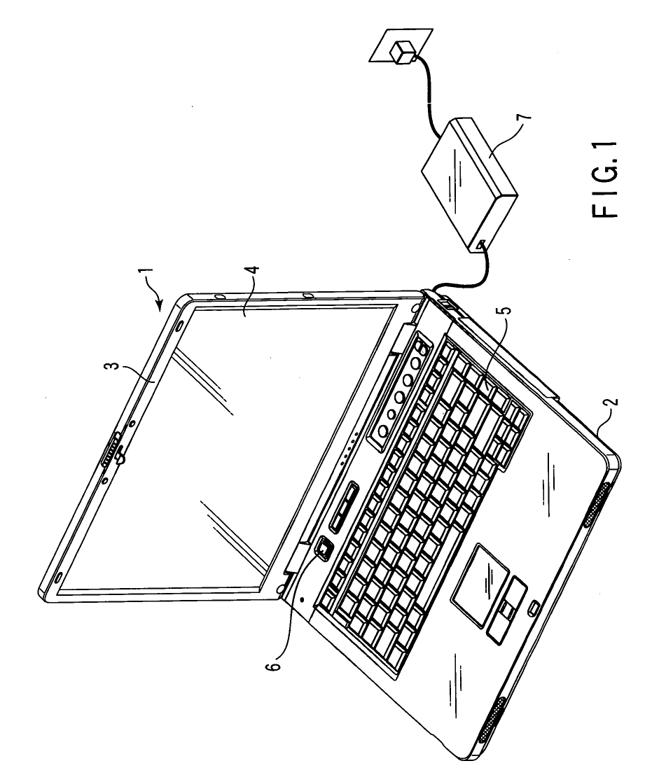

FIG. 1 is a perspective view showing an example of an information processing apparatus to which a state control method according to an embodiment of the present invention is applied, that is, notebook personal computer (referred to as computer, hereinafter) 1. Incidentally, FIG. 1 shows a state that a display unit 3 is opened with respect to a main body 2.

The computer 1 is composed of main body 2 and display unit 3. The display unit 3 has a built-in display device having a liquid crystal display (LCD) 4. The LCD 4 is positioned at the center of the display unit 3.

The display unit 3 is attached to the main body 2 so that it is rotatable between an opening position and a closed position. The main body 2 has substantially a box shape. The upper surface of the body 2 is provided with keyboard 5, power button 6 for turning on/off power of the computer 1, etc. The power button 6 is pressed to start up the computer 1.

The rear side of the main body 2 is provided with a connector, which is connected with cable for making a connection with an AC adapter 7. The AC adapter 7 is connected to an external power source such as commercial utility source, and supplies power to the computer 1. The configuration of the computer 1 will be explained below.

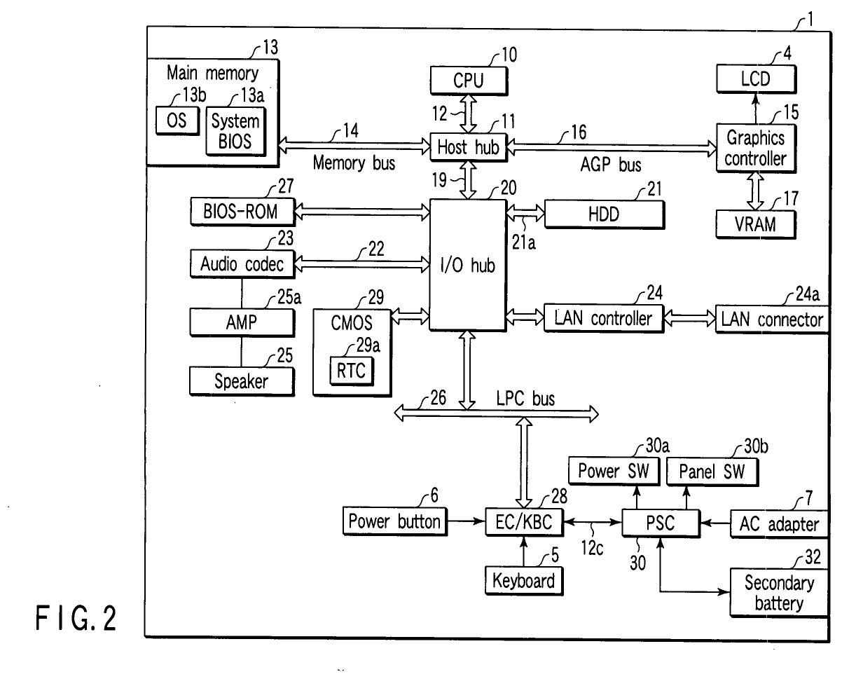

FIG. 2 is a functional block diagram showing an example of the configuration of the computer 1.

A host hub (first bridge circuit) 11 is connected with the following components via each bus. One of connected is a CPU 10 via a system bus 12, and another is a main memory 13 via a memory bus 14. Another connected is a graphics controller 15 via an AGP bus 16, and another is an input/output (I/O) hub 20 via a bus 19.

The host hub 11 is connected with the CPU 10 via the system bus 12. The host hub 11 has a built-in memory controller (not shown), which controls an access to the main memory 13 via the memory bus 14.

The CPU 10 is a main processor controlling the system of the computer 1. The CPU 10 executes operating system (OS) 13b, application program and utility program, which are loaded from an external storage, that is, a hard disk drive (HDD) 21 to the main memory 23 via the memory bus 14.

Moreover, the CPU 10 executes system Basic Input Output System (BIOS) 13a loaded from a BIOS-ROM 27 to the main memory 13.

The graphics controller 15 connected to the host hub 11 via Accelerated Graphics Port (AGP) bus 16 outputs a digital display signal. The graphics controller 15 is connected with a video memory (VRAM) 17. The graphics controller 15 displays data drawn to the VRAM 17 according to OS/application program on the LCD 4.

The I/O hub (second bridge circuit) 20 connected via the host hub 11 and dedicated bus such as hub interface controls various devices on a low pin count (LPC) bus 26.

The I/O hub 20 is connected with an external storage, that is, the HDD 21, which supports a serial ATA standard, via a serial ATA bus 21a supporting the serial ATA standard.

The HDD 21 is a magnetic disk device. The HDD 21 is stored with operating system (OS) 13b, application program, utility program and data generated by using the application program.

The I/O hub 20 is further connected with LAN controller 24, audio codec 23, BIOS-ROM 27 and CMOS 29.

The LAN controller 24 is a communication controller, and provided with a media access control (MAC) and physical layer (PHY) transceiver. The LAN controller 24 makes communications with other communication device according to a predetermined communication protocol. In this case, the LAN controller 24 makes communications using several communication modes having different transmission rate.

The LAN controller 24 is connected with a LAN connector 24a. An RJ-45 connector comprising insulation transformer is given as one example of the LAN connector 24a.

The audio codec 23 is connected to the I/O hub 20 via an Audio Code (AC) 97 (22). The audio codec 23 is one kind of sound input/output code. The audio codec 23 has a codec unit and the like for sound to be input and output.

The audio codec 23 is connected with an AMP 25a. The AMP 25a amplifies a sound signal generated by the audio codec 23. The sound signal amplified by the AMP 25a is sent to a speaker 25, and thereafter, the speaker 25 outputs a sound wave having an audible frequency band.

The BIOS-ROM 27 is a storage medium storing system BIOS 13a. The storage medium used as the BIOS-ROM 27 is a program rewritable storage medium, for example, flash memory.

The system BIOS 13a is a program systemizing a function execution routine for accessing various hardware. The system BIOS 13a includes IRT routine for executing initialization and test of various devises when the system is powered on and driver group for controlling various hardware.

The complementary metal-oxide semiconductor (CMOS) 29 has a real-time clock (RTC) 29a. The RTC 29a is a module for counting date and time, and operated using power supplied from a built-in battery in a system power off state.

The CMOS 29 is stored with setting contents specified using a BIOS setup screen. The LPC bus 26 is connected with an embedded controller/keyboard controller IC (EC/KBC) 28.

The embedded controller/keyboard controller IC (EC/KBC) 28 is a one-chip microcomputer, which is integrated with the following controllers. One is an embedded controller for executing power management, and another is a keyboard controller for controlling a keyboard (KB) unit 5.

The EC/KBC 28 is connected with keyboard unit 5, power button 6 and power supply controller (PSC) 30.

Moreover, the EC/KBC 28 has a power sequence control function of controlling system power on/off in cooperation with the PSC 30, and a power status notification function.

According to the power status notification function, the EC/KBC 28 monitors a startup factor of starting a resume process routine, that is, a generation of wakeup event in cooperation with the PSC 30. Then, when a wakeup event generates, the EC/KBC 28 gives notification that event generates, to the system BIOS 13a using system management interrupt SMI.

The following operations are given as the wakeup event. One is turn on of a power switch 30a in accordance with a press operation of the power button 6. Another is turn on of a panel switch 30b in accordance with an operation that the display unit 3 is opened from the closed state with respect to the main body 2.

The EC/KBC 28 has an I/O port for making communications with the system BIOS 13a. The system BIOS 13a executes read/write with respect to a configuration register included in the EC/KBC 28 via the I/O port. By doing so, the EC/KBC 28 reads a status showing the generated event, and sets the kind of an event monitored and notified. Communications between the EC/KBC 28 and the PSC 30 are made via a bus 12C.

The PSC 30 supplies power supplied from the AC adapter 7 or secondary battery 32 to each module included in the computer 1. The secondary battery 32 is replaceable. If power is supplied from the AC adapter 7 to the computer 1, power supplied from the AC adapter 7 is stored in the secondary battery 32 via the PSC 30.

When user presses the power button 6, the EC/KBC 28 detects that the power button 6 is operated. When detecting that the power button 6 is operated, the EC/KBC 28 gives notice of starting the power supply to the system of the computer 1 to the PSC 30. Based on the notice from the EC/KBC 28, the PSC 30 starts the power supply to the system of the computer 1 from the AC adapter 7 or secondary battery 3. The following is an explanation about a system state according to the present invention.

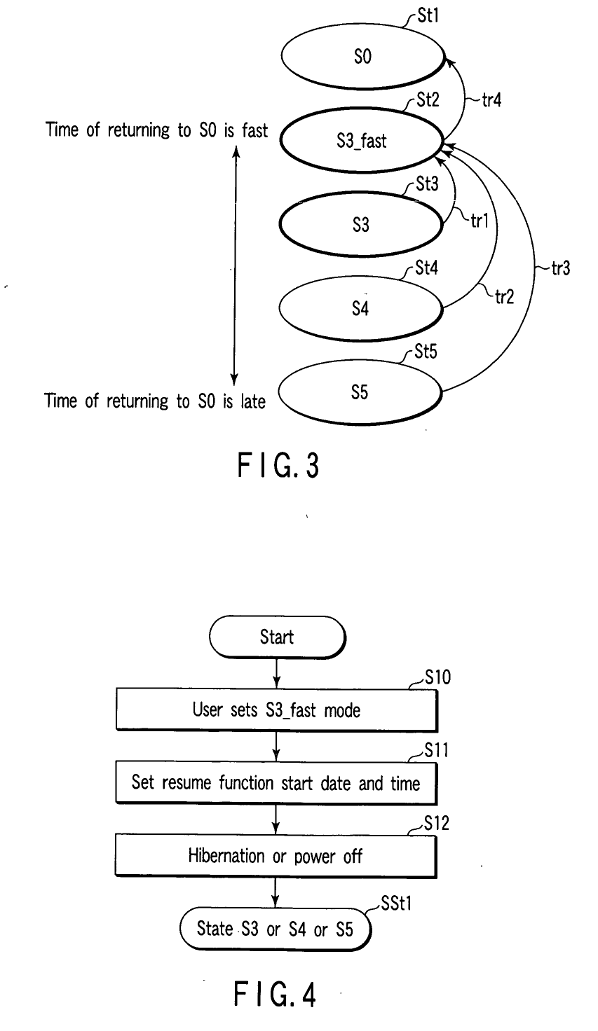

FIG. 3 is a first view to explain an example of the relationship between a system state according to the present invention and a system state defined in ACPI.

A state calling S3_fast (St2) is defined as the system state according to the present invention. The state S3_fast (St2) is a state given between states S0 (St1) and S3 (St3). Moreover, the state S3_fast (St2) is a state returnable to S0 (St1) at time faster than time to return from state S3 (St3) to S0 (St1).

The following transitions are given as a transition mode from the system state defined by the ACPI to the state S3_fast (St2).

Transition (tr 3) from state S5 (St5) to S3_fast (St2).

Transition (tr 2) from state S4 (St4) to S3_fast (St2).

Transition (tr 1) from state S3 (St3) to S3_fast (St2).

Moreover, a transition (tr 4) from S3_fast (St2) to S0 (St1) is given as a transition mode from the state S3_fast (St2) to the system state defined by the ACPI.

FIG. 4 is a flowchart to explain an example of the procedure of transiting the system state to state S3 or S4 or S5 after user sets an S3_fast mode.

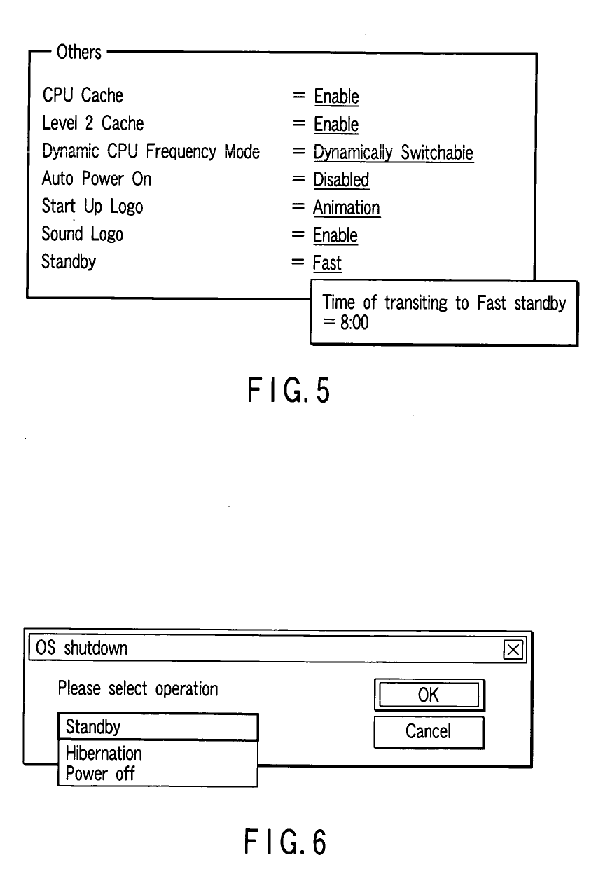

User using the computer 1 does settings so that the S3_fast mode becomes active (valid) (step S10). The settings are made in the following manner. For example, as shown in FIG. 5, a BIOS setup screen is displayed before the OS starts up, and then, the S3_fast mode is set.

In order to set the S3_fast mode using the displayed BIOS setup screen shown in FIG. 5, an item “Standby” shown in FIG. 5 is set to “fast”. On the other hand, in order to set the state S3 defined by the ACPI, the item “Standby” is set to “normal”.

When user sets the S3_fast mode via the BIOS setup screen, a value showing the S3_fast mode is stored in the CMOS 29. The procedure sequence returns to the flowchart shown in FIG. 4.

User sets date and time of starting a resume process for returning from S3, S4 or S5 to S3_fast (step S11). Settings for resume process start date and time are made using the BIOS setup screen (see FIG. 5). FIG. 5 shows an example of a screen display when a resume process for returning S3_fast is started at 8:00. In the manner described above, date and time are set, and thereafter, when the set date and time come, the system BIOS 13a starts the resume process according to wakeup of the RTC 29a. The system state transits to the state S3_fast in the following manner. Specifically, if resume process start at specified date and time is set, when the resume process is started at the specified date and time, the system state transits from S3, S4 or S5 to S3_fast.

After setting the foregoing steps S10 and S11, user makes an operation of transiting the system state of the computer 1 to S3, S4 or S5 (step s12). The operations of transiting to S3, S4 or S5 are as follows. Transition to S5 is made in a manner of displaying a window shown in FIG. 6 in a state that the system state of the computer 1 is in state S0 to start power off (i.e., select “Power off” in the window of FIG. 6). Transition to S4 is made in a manner of displaying the window shown in FIG. 6 to start hibernation (i.e., select “Hibernation” in the window of FIG. 6). Transition to S3 is made in a manner of displaying the window shown in FIG. 6 to start standby (i.e., select “standby” in the window of FIG. 6).

User makes the foregoing operations, and thereby, the system state of the computer 1 transits to S3, S4 or S5 (state SSt1). Transition from S3, S4 or S5 to S3_fast will be explained below.

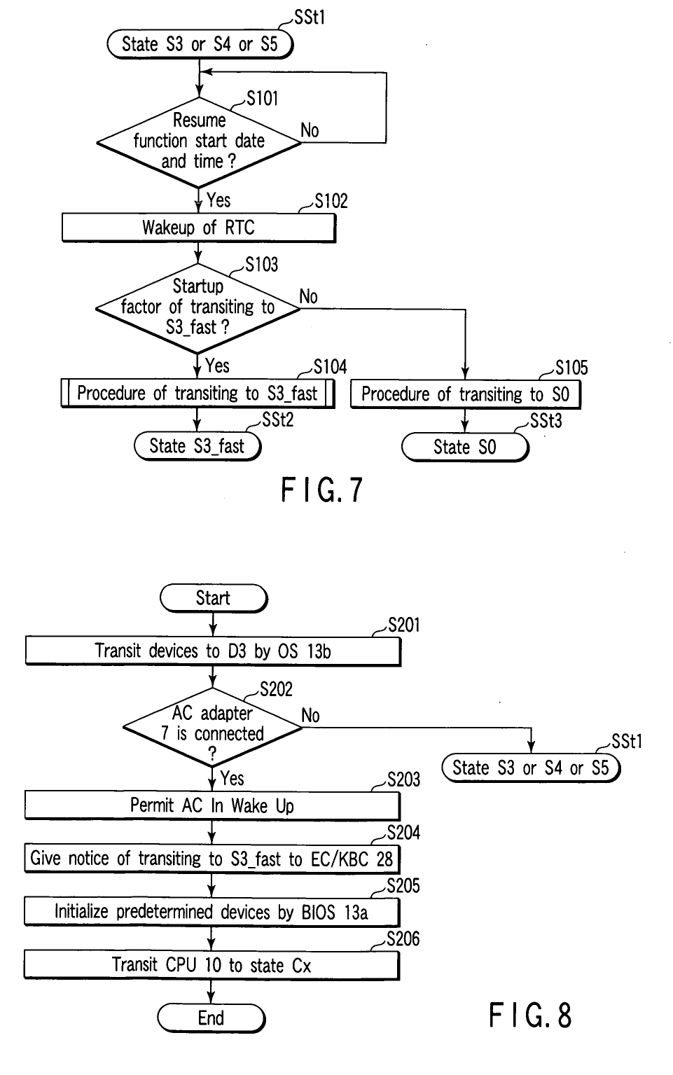

FIG. 7 is a flowchart to explain an example of the procedure of transiting from S5, S4 or S3 to S3_fast.

A standby mode is set to a S3_fast mode, and the system state of the computer 1 is set to state S3, S4 or S5. In this case, if the resume process start date and time set in step S11 described in the flowchart of FIG. 4 comes (step S101, Yes), the system starts up according to wakeup of the RTC 29a (step S102).

Upon detecting the wakeup of the RTC 29a, the system BIOS 13a determines whether or not the wakeup of the RTC 29a is a startup factor of transiting to S3_fast (step S103).

If the system BIOS 13a determines that the wakeup of the RTC 29a is a startup factor of transiting to S3_fast (step S103, Yes), the procedure of transiting to S3_fast is taken (step S104). Incidentally, in order to transit the system state from s3, S4 or S5 to S3_fast, the system state transits from S3, S4 or S5 to S0, and thereafter, transits from S0 to S3_fast. When the procedure of transiting to S3_fast ends, the system state becomes S3_fast (state SSt2).

On the other hand, if the system BIOS 13a determines that the wakeup of the RTC 29a is not a startup factor of transiting to S3_fast (step S103, No), the procedure of transiting to S0 is taken (step S105). When the procedure of transiting to S0 ends, the system state becomes S0 (state SSt3). The procedure of transiting to S3_fast taken in step S104 will be explained below.

FIG. 8 is a flowchart to explain an example of the procedure of transiting to S3_fast.

First, the OS 13b transits each device condition (status) of predetermined devices configuring the system of the computer 1 to D3 (step S201).

The device condition implies a device power management state defined by ACPI, and states D0 to D3 are given. State D0 is an operating state that device is fully active, and D3 is an operating state that no power is supplied to portion excluding device core.

State D3 includes two states, that is, D3hot and D3cold. State D3hot is a state of transiting from D3 to D0 without initializing device when the system returns. State D3cold is a state of transiting from D3 to D0 after initializing device when the system returns.

By comparison with time of transiting from D3hot to D0 and time of transiting from D3cold to D0, there is no need of executing device initialization in transition from D3hot to D0. Therefore, state D3hot transits to D0 faster than state D3cold. In step S201, devices capable of transiting to D3hot transit to D3hot. On the other hand, devices (e.g., graphics controller) incapable of transiting to D3hot transit to D3cold.

The device state transits to D3, and thereafter, the system BIOS 13a reads a value of a register built in the EC/KBC 28 to determine whether or not the AC adapter 7 is in a connected state (step S202).

If determines that the AC adapter 7 is in a connected state (step S202, Yes), the system BIOS 13a gives notice of permitting AC In Wake Up to the EC/KBC 28 (step S203). According to the foregoing AC In Wake Up, connecting the AC adapter 7 to the computer 1 is regarded as a wakeup factor.

Moreover, the system BIOS 13a gives notice of transiting to S3_fast to the EC/KBC 28 (step S204). The system BIOS 13a initializes D3cold devices so that they transit to state D0 (step S205).

Thereafter, the system BIOS 13a transits a state of the CPU 10 to a state Cx (step S206). State Cx of the CPU 10 implies that no initialization of the CPU 10 by the system BIOS 13a is required when returning to S0, and the CPU 10 is in a power saving state as much as possible.

If the CPU 10 supports a state C4, the system BIOS 13a transits the state of the CPU 10 to state C4. State C4 of the CPU 10 is a state of stopping the lock supply to the CPU 10. If the CPU does not support state C4, the system BIOS 13a transits the state of the CPU 10 to a state C2.

On the other hand, if it is determined in step S202 that the AC adapter 7 is not connected (step S202, No), the computer system state is intactly kept at state S3, S4 or S5 (SStl).

As described above, the state S3_fast having no need of initializing devices and CPU when returning to state S0 is provided. By doing so, return to state S0 is achieved at high speed. Moreover, the state of the CPU 10 in state S3_fast transits to state Cx, and thereby, power saving can be achieved.

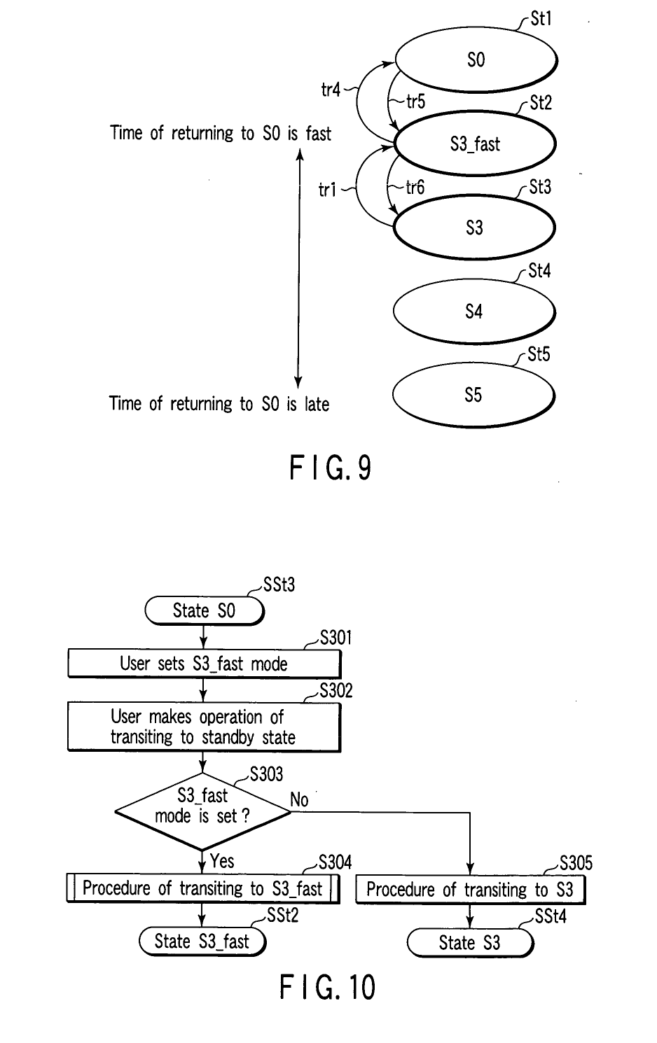

FIG. 9 is a second view to explain an example of the relationship between state S3_fast and system state defined by ACPI.

The definition of the state S3_fast is as described with reference to FIG. 3. The following transitions are given as a transition mode from a system state defined by ACPI to state S3_fast (St2).

Transition (tr5) from S0 (St1) to S3_fast (St2).

Transition (tr1) from S3 (St3) to S3_fast (St2)

Moreover, the following transitions are given as a transition mode from state S3_fast (St2) to a system state defined by ACPI.

Transition (tr6) from S3_fast (St2) to S3 (St3).

Transition (tr4) from S3_fast (St2) to S0 (St1).

Transition from S0 to S3_fast will be explained below.

FIG. 10 is a flowchart to explain an example of the procedure of transiting state s0 (SSt3) to state S3_fast (SSt2).

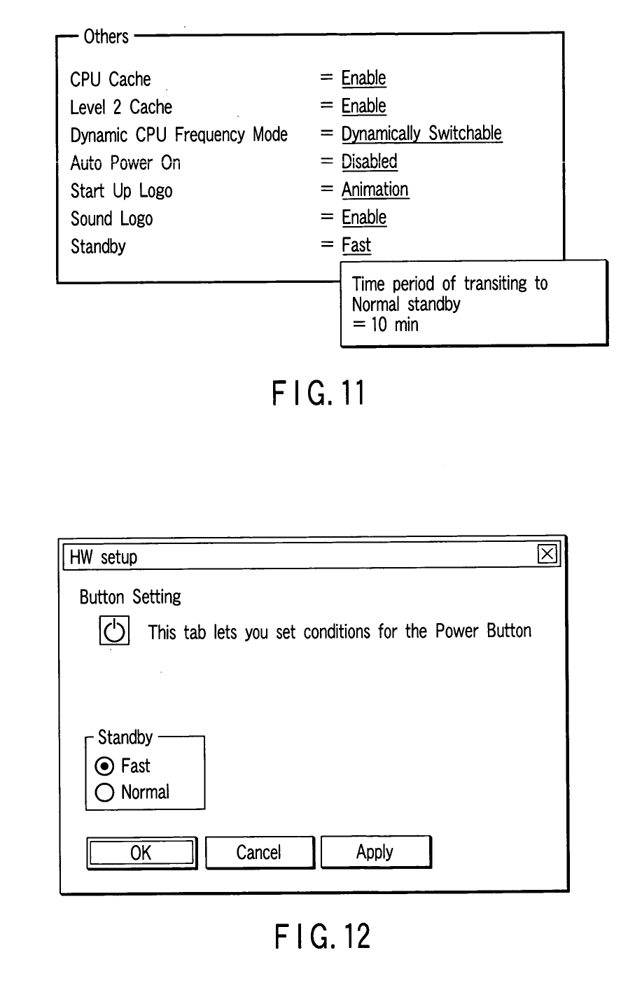

User using the computer 1 makes settings so that an S3_fast mode becomes active (valid) (step S301). The settings are made in the following manner. For example, as shown in FIG. 11, a BIOS setup screen is displayed before the OS starts up, and then, S3_fast mode is set. Moreover, as depicted in FIG. 12, the OS 13b starts up, and thereafter, utility for setting any of S3 mode and S3_fast mode is started up to set S3_fast mode.

In order to set S3_fast mode using the displayed BIOS setup screen (see FIG. 11) is, an item “Standby” is set to “fast”. On the other hand, in order to set the S3 mode defined by the ACPI, the item “Standby” is set to “normal”.

Moreover, user specifies time from a generation of predetermined event to transition start from S3_fast to S3, using the BIOS setup screen. In this embodiment, an event of removing the AC adapter 7 from the computer 1 is given as the predetermined event, although described later.

On the other hand, in order to set S3_fast mode using the started utility (see FIG. 12), user selects “fast” in the item “Standby”. On the other hand, in order to set S3 mode defined by the ACPI, user selects “normal” in the item “Standby”. When user starts up utility and sets S3_fast mode, time set as a default is used as time from a generation of predetermined event to transition start from S3_fast to S3.

When S3_fast mode is set via the BIOS setup screen or utility, a value showing S3_fast mode is stored in the CMOS 29.

User desires to transit the system state of the computer 1 from S0 to standby state. In this case, user makes an operation of starting a standby process using the window shown in FIG. 6 (step S302).

The system BIOS 13a determines whether or not S3_fast mode is set as a standby mode (step S303). If the system BIOS 13a determines that the S3_fast mode is set as a standby mode (step S303, Yes), the procedure of transiting to S3_fast is taken (step S304). The procedure taken in step S304 is the same as described using the flowchart shown in FIG. 8.

When the procedure of transiting to S3_fast ends, the system state becomes S3_fast (state SSt2).

On the other hand, if the system BIOS 13a determines that S3_fast mode is not set as a standby mode, that is, S3 mode is set (step S303, No), the procedure of transiting to S3 is taken (step S305).

When the procedure of transiting to S3 ends, the system state becomes S3 (state SSt4). Transition from S3_fast to S3 and transition from S3 to S3_fast will be explained below.

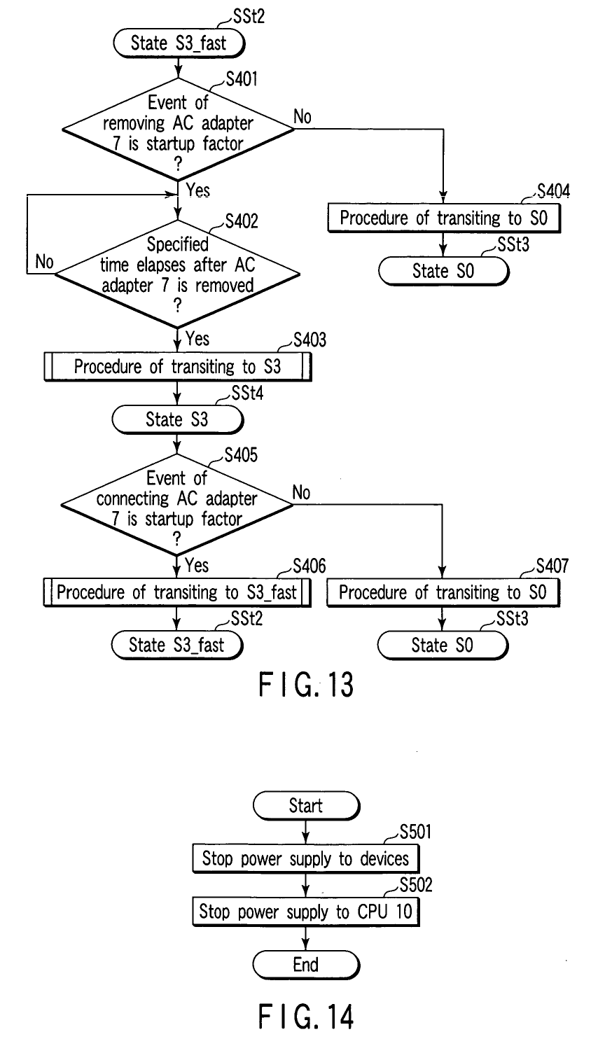

FIG. 13 is a flowchart to explain an example of the transition from state S3_fast (SSt2) to state S3 (SSt4) and the transition from state S3 (SSt4) to state S3_fast (SSt2).

User removes AC adapter 7 connected to the computer 1 of state S3_fast (state SSt2). If the system BIOS 13a determines that an event of removing AC adapter 7 is a startup factor (step S401, Yes), the following procedure is taken. That is, the system BIOS 13a determines whether or not predetermined time elapses from a generation of the event of removing AC adapter 7 (step S402). The predetermined time is settable in a manner that user specifies time using the displayed BIOS setup screen, as described using FIG. 11.

If the system BIOS 13a determines that the predetermined time elapses after the AC adapter 7 is removed (step S402, Yes), the procedure of transiting from S3_fast to S3 (step S403) is taken. The procedure of transiting from S3_fast to S3 will be explained later. When the procedure of transiting to S3 ends, the system state becomes state S3 (state SSt4).

Predetermined time elapses after the AC adapter 7 is removed from the computer 1, and thereafter, the system state transits from S3_fast to S3. By doing so, the computer 1 is operated using power supplied from the secondary battery 32 and not AC adapter 7 for a long time as compared with S3_fast.

On the other hand, if the system BIOS 13a does not determine that an event of removing AC adapter 7 is a startup factor (step S401, No), the procedure of transiting from S3_fast to S0 is taken (step S404). When the procedure of transiting to S0 ends, the system state becomes state S0 (state SSt3).

User connects the AC adapter 7 to the computer of state S3 (state SSt4) transiting from S3_fast. If the system BIOS 13a determines that an event of connecting the AC adapter 7 is a startup factor (step S405, Yes), the procedure of transiting from S3 to S3_fast is taken (step S406). The procedure of transiting from S3 to S3_fast is the same as described using FIG. 8. When the procedure of transiting to S3_fast ends, the system state becomes S3_fast (SSt2).

As described above, when the AC adapter 7 is connected to the computer 1 of state S3, the system state transits from S3 to S3_fast. By doing so, the system state is returnable to S0 at high speed as compared with the case of returning from S3 to S0.

On the other hand, the system BIOS 13a does not determines that an event of connecting the AC adapter 7 is a startup factor (step S405, No), the procedure of transiting from S3 to S0 is taken (step S407). When the procedure of transiting from S3 to S0 ends, the system state becomes state S0 (state SSt3). The procedure of transiting from S3_fast to S3 will be explained below.

FIG. 14 is a flowchart to explain an example of the procedure of transiting from S3_fast to S3.

First, the system BIOS 13a determines that predetermined time elapses after the AC adapter 7 is removed. In this case, the system BIOS 13a maintains power of the main memory 13 (and partial chipset) while stopping the power supply to predetermined devices whose device states are D3 (step S501). Incidentally, the power supply is stopped with respect to predetermined devices transiting to D0 by initialization described in step S205 shown in FIG. 8. In the procedure in step S501, the system BIOS 13a gives notice of transition to S3 to the I/O hub 20.

The system BIOS 13a further stbps the power supply to the CPU 10 (step S502). In the procedure in step S502, the system BIOS 13a gives notice of transition to S3 to the I/O hub 20.

According to this embodiment, when predetermined time elapses after the AC adapter 7 is removed from the computer 1 of state S3_fast, the system state transits from S3_fast to S3. In this case, the following configuration may be employed. Specifically, when predetermined time elapses after the system state transits from an arbitrary state to S3_fast regardless of connecting the AC adapter 7 to the computer 1, the system state transits from S3_fast to S3.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a device configured to support a specification defined in ACPI;
a processor configured to support a specification defined in ACPI;
a first state control unit configured to transit a state of the device to a first state requiring no initialization in return; and
a second state control unit configured to transit a state of the processor to a second state requiring no initialization in return.

2. The apparatus according to claim 1, wherein the first state control unit includes a first transit unit to transit the state of the device to a power saving state, and the second state control unit includes a second transit unit to transit the state of the processor to a power saving state.

3. The apparatus according to claim 1, further comprising:
a specifying unit configured to specify time when the first state control unit transits the state of the device to the first state and the second state control unit transits the state of the processor to the second state.

4. The apparatus according to claim 1, further comprising:
a setting unit configured to set whether or not each function of the first and second state control unit are made valid.

5. The apparatus according to claim 1, further comprising:
an AC adapter configured to provide power supplied to the device and the processor;
a determination unit configured to determine whether or not the AC adapter is connected to the apparatus; and
a power controller configured to stop a power supply to the device excluding a main memory and the processor if the determination unit determines that the AC adapter is not connected to the apparatus when the state of the device is in the first state and the state of the processor is in the second state.

6. The apparatus according to claim 5, wherein if the determination unit determines that the AC adapter is not connected to the apparatus, the power controller stops the power supply to the device and the processor when predetermined time elapses after the AC adapter is removed from the apparatus.

7. The apparatus according to claim 6, further comprising:
a specifying unit configured to specify the predetermined time.

8. The apparatus according to claim 5, wherein when the determination unit determines that the AC adapter is connected to the apparatus in a state that the power supply to the device and the processor is stopped, the first state control unit transits the state of the device to the first state while the second state control unit transits the state of the processor to the second state.

9. An information processing apparatus comprising:
a device configured to support a specification defined in ACPI;
a processor configured to support a specification defined in ACPI;
a first state control unit configured to transit a state of the device to a state D3hot and transit a state of a device incapable of transiting to the state D3hot to a state D3cold;
a unit configured to initialize the device of the state D3cold after transiting the state of the device to the state D3cold; and
a second state control unit configured to transit a state of the processor to a state Cx.

10. A state control method used for an information processing apparatus including a device configured to support a specification defined in ACPI and a processor configured to support a specification defined in ACPI, the comprising:
transiting a state of the device to a first state requiring no initialization in return; and
transiting a state of the processor to a second state requiring no initialization in return.

11. The method according to claim 10, wherein the first state includes a power saving state of the device, and the second state includes a power saving state of the processor.

12. The method according to claim 10, further comprising:
specifying time of transiting the state of the device to the first state and transiting the state of the processor to the second state.

13. The method according to claim 10, further comprising:
setting whether or not each function of transiting the state of the device to the first state, and transiting the state of the processor to the second state are made valid.

14. The method according to claim 10, further comprising:
determining whether or not an AC adapter providing power supplied to the device and the processor is connected to the apparatus; and
stopping a power supply to the device and the processor if it is determined that the AC adapter is not connected to the apparatus when the state of the device is the first state and the state of the processor is the second state.

15. The method according to claim 14, further comprising:
stopping the power supply to the device and the processor when predetermined time elapses after the AC adapter is removed from the apparatus if it is determined that the AC adapter is not connected to the apparatus.

16. The method according to claim 15, further comprising:
specifying the predetermined time.

17. The method according to claim 14, further comprising:
transiting the state of the device to the first state while transiting the state of the processor to the second state when it is determined that the AC adapter is connected to the apparatus in a state that the power supply to the device and the processor is stopped.
